(19) United States
(12) Patent Application Publication
(10) Pub. No.: US 2026/0192702 A1
(43) Pub. Date: Jul. 9, 2026

(54) BATTERY REPLACEMENT SYSTEM

(71) Applicant: TOYOTA JIDOSHA KABUSHIKI KAISHA, Toyota-shi Aichi-ken (JP)

(72) Inventors: Atsushi MIKUNI, Toyota-shi Aichi-ken (JP); Shintaro KITAKATA, Toyota-shi Aichi-ken (JP); Reiji IWAIHARA, Toyota-shi Aichi-ken (JP); Takumi KAWATA, Toyota-shi Aichi-ken (JP); Norihisa NOMURA, Ogaki-shi Gifu-ken (JP)

(73) Assignee: TOYOTA JIDOSHA KABUSHIKI KAISHA, Toyota-shi Aichi-ken (JP)

(21) Appl. No.: 19/134,970

(22) PCT Filed: Nov. 28, 2023
(86) PCT No.: PCT/IB2023/061957

§ 371 Date: Jun. 2, 2025

(30) Foreign Application Priority Data
Dec. 5, 2022 (JP) 2022-194386

(51) Int. Cl. B60L 53/80; B60K 1/04; B60L 53/66; B60S 3/04

(52) U.S. Cl. CPC B60L 53/80; B60K 1/04; B60L 53/66; B60S 3/04; B60K 2001/0472; B60L 2240/12; B60L 2250/10

(57) ABSTRACT

A battery replacement system for replacing a first battery attached to a vehicle, with a second battery includes a battery replacement mechanism configured to detach the first battery from the vehicle and attach the second battery to the vehicle, and a washing device configured to wash part of the vehicle. The washing device is configured to, before the battery replacement mechanism detaches the first battery, wash at least one of an area of the vehicle where the battery replacement mechanism contacts with the vehicle and an under side of the vehicle.

### CROSS-REFERENCE TO RELATED APPLICATIONS

The present application is the US National Phase entry of International Patent Application No. PCT/IB2023/061957 filed Nov. 28, 2023, which claims priority to Japanese Patent Application No. 2022-194386 filed Dec. 5, 2022, the entire contents of which are herein incorporated by reference.

### BACKGROUND

### 1. Technical Field

The disclosure relates to a battery replacement system.

### 2. Description of Related Art

Japanese Unexamined Patent Application Publication No. 2012-192782 (JP 2012-192782 A) describes a battery replacement system that replaces a battery mounted on a vehicle with a new battery. The battery is fixed to the vehicle by a battery supporting portion provided with a lock mechanism. The battery replacement system attaches and detaches a battery unit from a lower side of the battery supporting portion. In the battery replacement system, a battery mounting portion capable of moving up and down is provided at a location corresponding to the battery supporting portion of the vehicle stopped in a vehicle stop area.

When the battery unit is replaced, the battery mounting portion is moved to a raised position to receive the battery, the lock mechanism is unlocked, and the used battery is received from the battery supporting portion of the vehicle stopped. Subsequently, the battery mounting portion is lowered to a standby position, the used battery is conveyed out, and a new, charged battery is mounted on the battery mounting portion. After that, the battery mounting portion is raised to the raised position, and a new battery is transferred to the battery supporting portion.

### SUMMARY

In JP 2012-192782 A, the battery supporting portion that supports the battery is provided on the under side of the vehicle. Alternatively, the battery supporting portion may be fixed to the side of the vehicle.

Depending on the situation of a driving road, weather, and the like, foreign matter, such as mud, snow, and ice, can adhere to the under side or side of the vehicle or the surface of the battery. In such a case, it may be difficult to release the lock mechanism that locks the battery to the battery supporting portion, with the result that there are concerns about interference with battery replacement work. When foreign matter, such as snow and ice, adheres, it is required to remove the foreign matter by using hot water, hot air, snow-melting agent, or the like.

When, for example, the battery mounting portion and the battery are positioned by engaging a positioning pin provided for the battery mounting portion with a positioning hole provided on the under side of the vehicle, there are concerns that the positioning pin cannot be inserted into the positioning hole due to foreign matter adhering to the positioning hole. Also, when foreign matter drops to a work area for replacing the battery and/or the battery mounting portion, there are concerns about impairment of operation of the battery mounting portion. Furthermore, when foreign matter is adhering to the battery at the time when a battery detached is stored in a warehouse, there are concerns that the warehouse is polluted by the foreign matter.

The disclosure provides a battery replacement system capable of reducing influence caused by foreign matter adhering to a vehicle.

An aspect of the disclosure relates to a battery replacement system. The battery replacement system for replacing a first battery attached to a vehicle, with a second battery includes a battery replacement mechanism configured to detach the first battery from the vehicle and attach the second battery to the vehicle, and a washing device configured to wash part of the vehicle. The washing device is configured to, before the battery replacement mechanism detaches the first battery, wash at least one of an area of the vehicle where the battery replacement mechanism contacts with the vehicle and an under side of the vehicle.

With the above configuration, at least one of the area of the vehicle where the battery replacement mechanism contacts with the vehicle and the under side of the vehicle is washed before the first battery is detached. Therefore, even when the vehicle is dirty due to foreign matter during driving, battery replacement can be performed in a state where foreign matter is removed. Thus, impairment of battery replacement due to foreign matter is suppressed.

The battery replacement system according to the above aspect may include a vehicle stop area where the vehicle is stopped. The washing device may be provided so as to be capable of washing the vehicle stopped in the vehicle stop area.

With the above configuration, it is possible to wash the vehicle in a state where the vehicle is stopped in the vehicle stop area. Therefore, in comparison with the case where the vehicle is washed in a moving state, foreign matter adhering to the vehicle is further reliably removed.

In the battery replacement system according to the above configuration, the vehicle stop area may have an opening that allows the battery replacement mechanism to pass through and a shutter configured to openably close the opening. The washing device may be configured to wash the under side of the vehicle in a state where the opening is closed by the shutter.

With the above configuration, it is possible to reduce entry of foreign matter or the like, dropping from the vehicle due to washing, to a lower side of the vehicle stop area through the opening.

In the battery replacement system according to the above configuration, the vehicle stop area may have a floor that faces the under side of the vehicle. The shutter may be provided so as to be at least partially located above the floor in a state where the opening is closed by the shutter.

With the above configuration, in a state where the opening is closed by the shutter, foreign matter, wash fluid, and the like, dropping from the vehicle from an area of the shutter above the floor toward the floor, is flowed. Thus, it is possible to guide foreign matter, wash fluid, and the like to outside the opening. As a result, entry of foreign matter, wash fluid, and the like into the opening is reduced.

In the battery replacement system according to the above configuration, the washing device may be configured to wash the under side of the vehicle by jetting wash fluid toward the vehicle. In this case, the floor may be provided with a drain channel configured to drain the wash fluid.

With the above configuration, stagnation of wash fluid, washing the vehicle, in the vehicle stop area is suppressed, and the wash fluid is drained through the drain channel.

The battery replacement system according to the above configuration may further include a vehicle information acquisition unit configured to acquire information from the vehicle. The vehicle information acquisition unit may be provided so as to be capable of acquiring stop information on a stop of the vehicle in the vehicle stop area. In this case, the washing device may be configured to, after the vehicle information acquisition unit acquires the stop information, start washing the under side of the vehicle.

With the above configuration, it is possible to carry out washing in a preparation period of the vehicle side and the battery replacement system side from when the vehicle stops to when replacement is actually started. Thus, it is possible to smoothly perform battery replacement.

The battery replacement system according to the above configuration may further include a vehicle information acquisition unit configured to acquire information from the vehicle. The washing device may be provided so as to be movable. In this case, the washing device may be configured to move to a washing location based on the information from the vehicle, acquired by the vehicle information acquisition unit.

With the above configuration, it is possible to place the washing device at an appropriate washing location based on information from the vehicle.

In the battery replacement system according to the above aspect, the under side of the vehicle may have a positioning hole for positioning with the battery replacement mechanism. The washing device may be configured to wash the positioning hole.

With the above configuration, when the positioning hole is washed to remove dirt from the positioning hole, it is possible to smoothly position the battery replacement mechanism and the vehicle.

In the battery replacement system according to the above configuration, the battery replacement mechanism may have an insertion portion provided so as to be insertable in the positioning hole. In this case, the battery replacement system may further include an insertion detector configured to detect whether the insertion portion is inserted in the positioning hole. The washing device may be configured to, when the insertion detector detects that the insertion portion is not inserted in the positioning hole, wash the positioning hole.

With the above configuration, when the insertion portion cannot be inserted in the positioning hole after the positioning hole is washed because of insufficient washing, it is possible to wash the positioning hole again.

The battery replacement system according to the above configuration may further include a warning notification unit configured to, when the insertion detector detects that the insertion portion is not inserted in the positioning hole after, repeatedly, the insertion detector detects that the insertion portion is not inserted in the positioning hole and the washing device washes the positioning hole, notify a warning.

With the above configuration, when washing of the positioning hole is repeatedly performed, the warning notification unit can notify that foreign matter is not completely removed by washing.

In the battery replacement system according to the above aspect, the washing device may be configured to wash the vehicle by jetting a washing medium toward the vehicle. The washing medium may include liquid or gas.

With the above configuration, it is possible to wash the under side of the vehicle with liquid or gas.

In the battery replacement system according to the above aspect, the liquid may include hot water or highly volatile wash fluid.

With the above configuration, when washing is performed with hot water, it is possible to melt foreign matter, such as snow and ice, and, when washing is performed with highly volatile wash fluid, it is possible to omit drying of the vehicle after washing.

In the battery replacement system according to the above aspect, the washing device may be configured to wash the vehicle by jetting liquid toward the vehicle. In this case, the battery replacement system may further include a drying device configured to dry the vehicle washed with the washing device.

With the above configuration, liquid adhering to the vehicle can be dried with the drying device after washing.

In the battery replacement system according to the above aspect, the washing device may be configured to wash the vehicle by jetting liquid toward the vehicle. In this case, the battery replacement system may further include a wiping device configured to wipe the liquid adhering to the vehicle washed with the washing device.

With the above configuration, liquid adhering to the vehicle can be wiped with the wiping device after washing.

In the battery replacement system according to the above aspect, the washing device may be configured to wash the vehicle by jetting a washing medium toward the vehicle. In this case, the battery replacement system may further include a heating device configured to heat the washing medium.

With the above configuration, when the washing medium is heated with the heating device, it is possible to melt foreign matter, such as snow and ice, at the time of washing the vehicle.

In the battery replacement system according to the above aspect, the first battery may be releasably fixed to a vehicle body by a plurality of fastening devices. The battery replacement mechanism may include a fixation releasing portion configured to release a fixed state where the first battery is fixed to the vehicle body by the plurality of fastening devices. In this case, the washing device may be configured to wash an area where the fixation releasing portion contacts with the fastening devices.

With the above configuration, when the area where the fixation releasing portion contacts with the fastening devices is washed, it is possible to easily release the fixed state made by the fastening devices with the fixation releasing portion.

In the battery replacement system according to the above aspect, the first battery may be fastened to the under side from a lower side with a plurality of fastening bolts. The plurality of fastening bolts each may have a head at the lower side. The battery replacement mechanism may include a fastening release portion configured to release fastening of the plurality of fastening bolts. In this case, the washing device may be configured to wash the head of each of the plurality of fastening bolts.

With the above configuration, when the head of each of the fastening bolts is washed, it is possible to easily release fastening of the fastening bolts with the fastening release portion.

In the battery replacement system according to the above configuration, the washing device may be configured to, before the second battery is attached to the vehicle, further wash the under side of the vehicle placed in a state where the first battery is detached by the battery replacement mechanism.

With the above configuration, it is possible to wash the area where the first battery overlaps on the under side of the vehicle.

The battery replacement system according to the above aspect may further include a vehicle stop area where the vehicle is stopped. In this case, the washing device may be provided forward of the vehicle stop area.

With the above configuration, it is possible to wash the under side of the vehicle before the vehicle enters the vehicle stop area.

In the battery replacement system according to the above aspect, the washing device may be configured to wash the vehicle by jetting liquid toward the vehicle. The battery replacement system may further include a drying device configured to dry the vehicle washed with the washing device. In this case, the washing device and the drying device may be disposed forward of the vehicle stop area so as to be arranged in a direction in which the vehicle enters. The drying device may be disposed closer to the vehicle stop area than the washing device.

With the above configuration, before the vehicle enters the vehicle stop area, it is possible to wash the vehicle with the washing device and then dry the vehicle. As a result, it is possible to reduce entry of foreign matter, adhering to the vehicle, into the vehicle stop area.

The battery replacement system according to the above configuration may further include a location detection mechanism configured to detect a location of the vehicle. In this case, the washing device may be configured to, when the location detection mechanism detects that the vehicle is located above the washing device, wash the vehicle.

With the above configuration, since washing is performed after the location detection mechanism detects the location of the vehicle, it is possible to reduce losses of a washing medium and reliably wash the vehicle.

In the battery replacement system according to the above aspect, the washing device may be provided so as to be capable of washing a surface of the first battery.

With the above configuration, it is possible to remove foreign matter adhering to the surface of the first battery. Thus, it is possible to reduce storage of the first battery in a warehouse in a state where foreign matter is adhering to the first battery detached.

According to the aspect of the disclosure, it is possible to provide a battery replacement system capable of reducing influence due to foreign matter adhering to an under side of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that shows the configuration of a battery replacement system according to a first embodiment;

FIG. 2 is a plan view that shows the configuration of an under side of a vehicle according to the first embodiment;

FIG. 3 is a diagram that shows the configuration of the vehicle according to the first embodiment;

FIG. 4 is a plan view that shows the configuration of a battery replacement station of the battery replacement system according to the first embodiment;

FIG. 5 is a schematic diagram that shows the underfloor configuration of the battery replacement system according to the first embodiment;

FIG. 6 is a perspective view that shows a battery mounting base of a battery replacement mechanism according to the first embodiment;

FIG. 7 is a flowchart that shows a battery replacement process of the battery replacement system according to the first embodiment;

FIG. 8 is a diagram that shows a process of washing an under side of the vehicle in the battery replacement process shown in FIG. 7;

FIG. 9 is a diagram that shows a state where the under side of the vehicle washed in the process of washing the under side of the vehicle is wiped with a wiping device;

FIG. 10 is a diagram that shows a state where an insertion portion of the battery mounting base is inserted into a positioning hole of the vehicle in a process of detaching a battery;

FIG. 11 is a diagram that shows a state where a lock-unlock tool is inserted into a tool insertion hole in the process of detaching the battery;

FIG. 12 is a diagram that shows a state where the lock-unlock tool unlocks a fastening bolt in the process of detaching the battery;

FIG. 13 is a diagram that shows a process of conveying the battery detached from the vehicle;

FIG. 14 is a diagram that shows a process of washing the under side of the vehicle after the battery is detached from the vehicle;

FIG. 15 is a diagram that shows a process of attaching a new battery to the vehicle;

FIG. 16 is a plan view that shows the configuration of a battery replacement station of a battery replacement system according to a second embodiment;

FIG. 17 is a flowchart that shows a battery replacement process of the battery replacement system according to the second embodiment; and

FIG. 18 is a plan view that shows the configuration of a battery replacement station of a battery replacement system according to a third embodiment.

### DETAILED DESCRIPTION OF EMBODIMENTS

Hereinafter, embodiments of the disclosure will be described in detail with reference to the accompanying drawings. In the embodiments described below, like reference signs denote the same or common portions, and the description thereof will not be repeated.

### First Embodiment

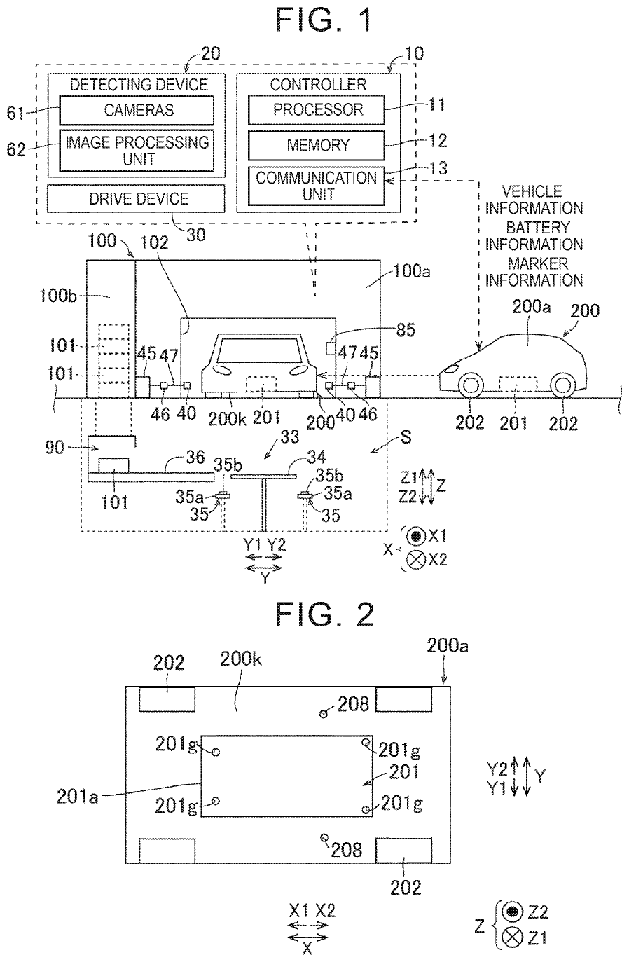

FIG. 1 is a diagram that shows the configuration of a battery replacement system according to a first embodiment. As shown in FIG. 1, the battery replacement system 100 is a system for replacing a battery (first battery) 201, attached to a vehicle 200, with another battery (second battery) 101. Another battery 101 may be a new battery or may be a battery replaced from the vehicle 200 at other timing and recharged.

The battery replacement system 100 includes a battery replacement station 100a where battery replacement is performed, and a warehouse 100b in which another battery 101 is stored. The warehouse 100b is located next to the battery replacement station 100a. The battery replacement station 100a has a floor 39. The battery replacement system 100 has an underfloor area S below the floor 39.

The battery replacement system 100 includes a battery replacement mechanism 33, a conveying unit 36, a washing device 40, a washing medium supply unit 45, a heater 46, a supply pipe 47, a drying device 50 (see FIG. 4), and a warning notification unit 85.

The battery replacement mechanism 33 is a device to detach the battery 201 from the vehicle 200 and attach another battery 101 to the vehicle 200. The battery replacement mechanism 33 is provided in the warehouse 100b and the underfloor area S. The battery replacement mechanism 33 includes a battery mounting base 34 and an elevating unit 35.

The battery mounting base 34 moves the battery 101 or the battery 201 between the conveying unit 36 and the vehicle 200. The elevating unit 35 moves up and down the vehicle 200 between a stop position to be stopped in the battery replacement station 100a and a predetermined height position. The conveying unit 36 moves the battery 101 or the battery 201 between a temporary storage space 90 and the battery mounting base 34. The conveying unit 36 may be, for example, a type of belt conveyor.

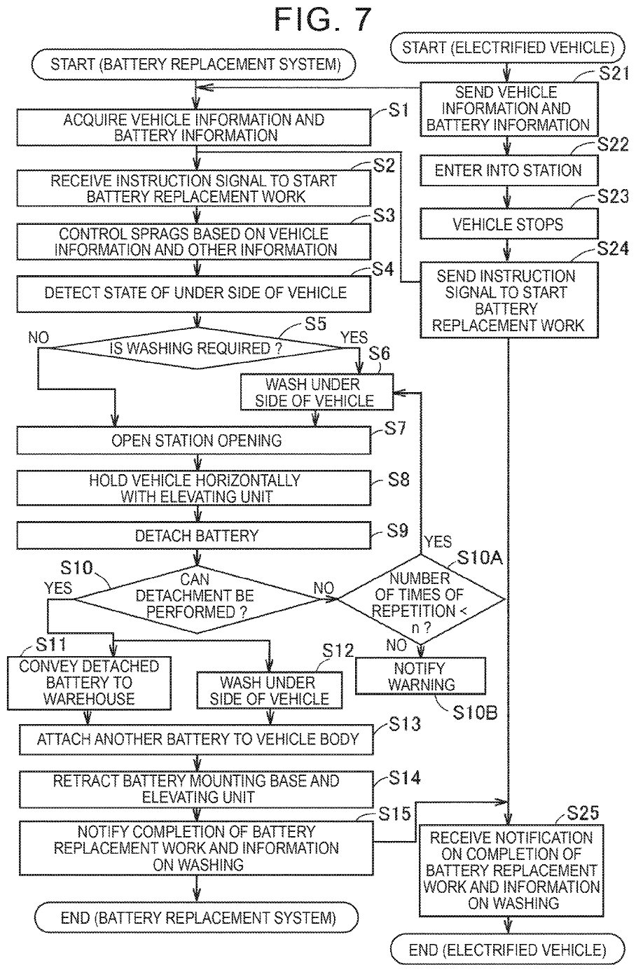

The conveying unit 36 conveys the battery 201, detached from the vehicle 200 and mounted on the battery mounting base 34, to the temporary storage space 90. Specifically, in a state where the battery mounting base 34 on which the battery 201 detached is mounted is lowered to the same height position (position in a Z direction) as the conveying unit 36, the battery 201 is transferred from the battery mounting base 34 to the conveying unit 36. The battery 201 is transferred by rotation of roller units 34c (see FIG. 6) of the battery mounting base 34.

The conveying unit 36 moves another battery 101, conveyed from the warehouse 100b to the temporary storage space 90, to a Y2 side to be mounted on the battery mounting base 34. At this time, the roller units 34c of the battery mounting base 34 rotate in a direction opposite to the above direction, so the battery 101 is transferred to the Y2 side on the battery mounting base 34.

Movement of the battery 101 or the battery 201 between the temporary storage space 90 and the warehouse 100b is performed by another conveying device (not shown).

The washing device 40, the washing medium supply unit 45, the heater 46, the supply pipe 47, and the warning notification unit 85 are provided in the battery replacement station 100a.

The washing medium supply unit 45 supplies a washing medium to the washing device 40 via the supply pipe 47. The washing medium may include liquid, such as water and wash fluid, or gas. The heater 46 heats a washing medium. Specifically, the heater 46 heats a washing medium flowing through the supply pipe 47. The heater 46 may heat a washing medium stored at the washing medium supply unit 45 side.

The washing device 40 washes part of the vehicle 200 by jetting a washing medium toward the vehicle 200. For example, the washing device 40 washes an under side 200k.

An area where the washing device 40 washes the vehicle 200 is not limited to the under side 200k and may be an area where the battery replacement mechanism 33 contacts with the vehicle 200. The area where the battery replacement mechanism 33 contacts with the vehicle 200 means an area where, when the battery 201 is detached from a vehicle body 200a, the battery replacement mechanism 33 contacts with the vehicle body 200a to release a fixed state of the vehicle body 200a with the battery 201, and its vicinities. When, for example, the battery 201 is fixed to a side of the vehicle 200, the side of the vehicle 200 may be washed.

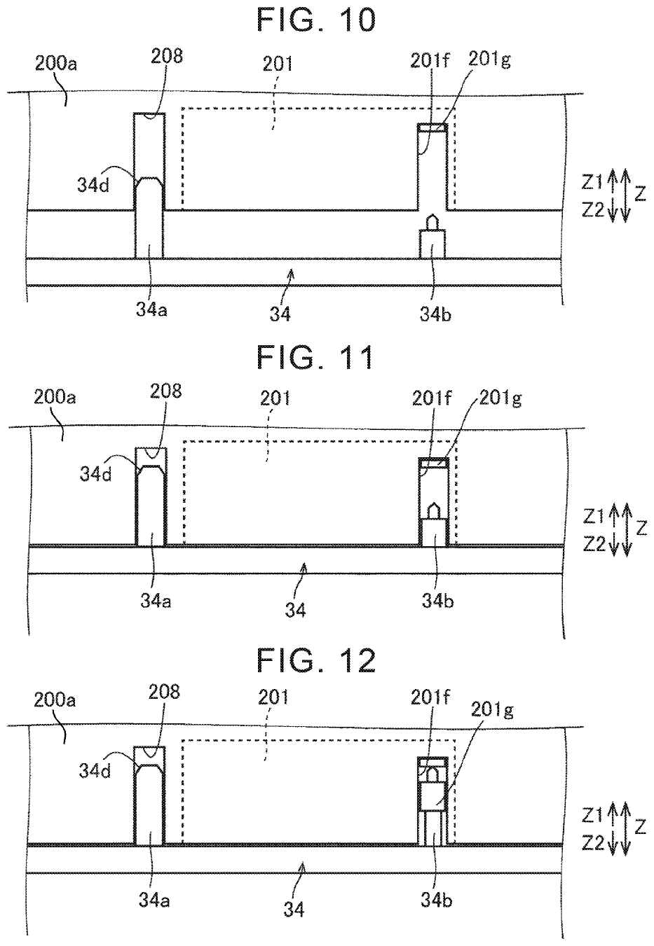

When the washing medium is heated with the heater 46 as described above, foreign matter, such as snow and ice, adhering to the vehicle 200 can be melted at the time of washing the vehicle 200. Particularly, when snow and/or ice is in positioning holes 208 or tool insertion holes 201f (see FIG. 10) (described later), it is effective. When the washing medium is not heated, a washing medium containing a snow-melting agent may be used to melt snow and/or ice.

Alternatively, a highly volatile wash fluid may be used as the washing medium. In this case, the wash fluid volatilizes after washing, so it is possible to simplify or omit drying of the vehicle 200.

The warning notification unit 85 notifies a warning when conditions (described later) are detected. The warning notification unit 85 includes, for example, a light source and blinks or lights up the light source at the time of notifying a warning. Alternatively, the warning notification unit 85 may include a sound source and may beep a sound from the sound source at the time of notifying a warning.

The battery replacement system 100 includes a controller 10, a detecting device 20, and a drive device 30. The detecting device 20 is an example of the insertion detector according to the aspect of the disclosure.

The controller 10 includes a processor 11, a memory 12, and a communication unit 13. The memory 12 stores not only a program to be run on the processor 11 but also information to be used by the program (for example, maps, mathematical expressions, and various parameters). The processor 11 controls the drive device 30. The drive device 30 includes the battery replacement mechanism 33, the conveying unit 36, the washing device 40, the washing medium supply unit 45, the heater 46, the supply pipe 47, the drying device 50 (see FIG. 4), and the warning notification unit 85.

The communication unit 13 includes various communication I/Fs. The processor 11 controls the communication unit 13. The communication unit 13 communicates with a DCM and the like of the vehicle 200. Bidirectional communication is possible between the communication unit 13 and the vehicle 200. The communication unit 13 may communicate with a mobile terminal owned by a user of the vehicle 200. The communication unit 13 is an example of a vehicle information acquisition unit that acquires information from a vehicle.

When the battery 201 is replaced, the user operates to issue instructions to start battery replacement work on a navigation system (not shown) of the vehicle 200 in a state where the vehicle 200 is stopped in a vehicle stop area 103. The communication unit 13 receives from the vehicle 200 an instruction signal to start battery replacement work. The processor 11 starts control for battery replacement work based on the instruction signal received by the communication unit 13.

The vehicle 200 may be operated so as to automatically stop in the vehicle stop area 103 in the battery replacement station 100a by the user operating the navigation system outside the battery replacement station 100a or may be stopped in the vehicle stop area 103 by the user driving the vehicle 200. The vehicle 200 stops in the vehicle stop area 103 such that a front and rear direction is an X direction and a right and left direction is a Y direction.

The detecting device 20 includes cameras 61 and an image processing unit 62. The details of the detecting device 20 will be described in detail later.

FIG. 2 is a plan view that shows the configuration of the under side of the vehicle according to the first embodiment. As shown in FIG. 2, the vehicle 200 includes the vehicle body 200a, a plurality of wheels 202, and the battery 201. The vehicle body 200a has the under side 200k.

The plurality of positioning holes 208 (described later) is provided on the under side 200k. The positioning holes 208 are provided outside the battery 201. The battery 201 is fixed to the under side 200k by a plurality of fastening bolts 201g. The fastening bolts 201g are respectively inserted in the tool insertion holes 201f (see FIG. 10) (described later).

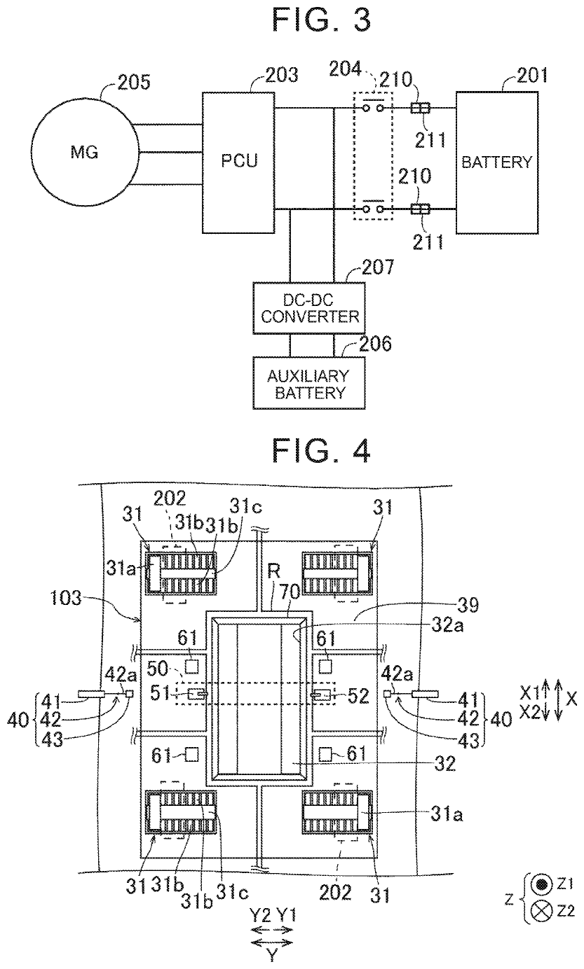

FIG. 3 is a diagram that shows the configuration of the vehicle according to the first embodiment. As shown in FIG. 3, the vehicle 200 includes a power control unit (PCU) 203, a system main relay (SMR) 204, a motor generator (MG) 205, an auxiliary battery 206, a DC-DC converter 207, a vehicle-side connector 210, and a connector 211 of the battery 201.

When the battery 201 is replaced, an ignition power (not shown) is turned off and the SMR 204 that connects the battery 201 with the PCU 203 is turned off in a state where the vehicle 200 is stopped in the vehicle stop area 103 (described later). Thus, the battery 201 is electrically disconnected from the PCU 203 and the MG 205.

When operation to issue instructions to start battery replacement work is performed in the vehicle 200 in this state, the battery replacement system 100 starts control for battery replacement work. Based on the operation performed, locking of the vehicle-side connector 210 with the connector 211 of the battery 201 is released. After the SMR 204 is turned off, electric power of the auxiliary battery 206 is supplied to the MG 205 and accessories such as the DCM via the DC-DC converter 207 and the PCU 203.

FIG. 4 is a plan view that shows the configuration of the battery replacement station of the battery replacement system according to the first embodiment. As shown in FIG. 4, four sprags 31 are provided in the vehicle stop area 103. The four sprags 31 are provided so as to respectively correspond to the four wheels 202.

Each of the sprags 31 includes a pressing member 31a, a pair of horizontal roller units 31b, and a slider 31c. The pressing member 31a is dispose astride the pair of horizontal roller units 31b and the slider 31c. The pressing member 31a moves the wheel 202 by pressing the wheel 202 from the outer side (laterally). Thus, the wheel 202 is positioned by the sprag 31.

The horizontal roller units 31b are respectively provided on an X1 side and an X2 side of the slider 31c. Each of the horizontal roller units 31b is made up of a plurality of rollers of which the rotation axes extend in the Y direction. The rollers of each horizontal roller unit 31b are arranged in the Y direction. When the rollers of the horizontal roller units 31b rotate, the pressing member 31a is moved in the Y direction.

The slider 31c moves the pressing member 31a mounted in the sprag 31 in the Y direction. The slider 31c may be, for example, a type of belt conveyor. The configuration of the sprag 31 is not limited to the above example. For example, any one of the slider 31c and the pair of horizontal roller units 31b does not need to be provided.

The washing device 40 is provided so as to be capable of washing the vehicle 200 stopped in the vehicle stop area 103. The washing device 40 includes movable bodies 41, arms 42, and nozzle units 43. Each movable body 41 is, for example, provided so as to be movable in the X direction and the Y direction. The movable body 41 may be provided so as to be movable also in the Z direction.

Each arm 42 is, for example, provided so as to be capable of extending and contracting in the Y direction. The arm 42 connects the movable body 41 with the nozzle unit 43. The arm 42 has a first part 42a at its distal end side. The first part 42a may be provided so as to be capable of changing an inclination angle with respect to the Z direction. A channel through which a washing medium flows is provided in the arm 42.

Each nozzle unit 43 is connected to the distal end of the arm 42. The nozzle unit 43 jets a washing medium, supplied from the washing medium supply unit 45, toward the vehicle 200 (more specifically, the under side 200k).

The vehicle stop area 103 has the floor 39. The floor 39 faces the under side 200k of the vehicle 200 stopped in the vehicle stop area 103 from the lower side. The opening 32a extending through the floor 39 and the shutter 32 are provided in the vehicle stop area 103. The opening 32a is provided so as to allow the battery replacement mechanism 33 to pass through. The shutter 32 openably closes the opening 32a. When the shutter 32 is open, the opening 32a is exposed. In the present embodiment, the example in which the shutter 32 is a double-acting door is shown. Alternatively, the shutter 32 may be a single-acting door.

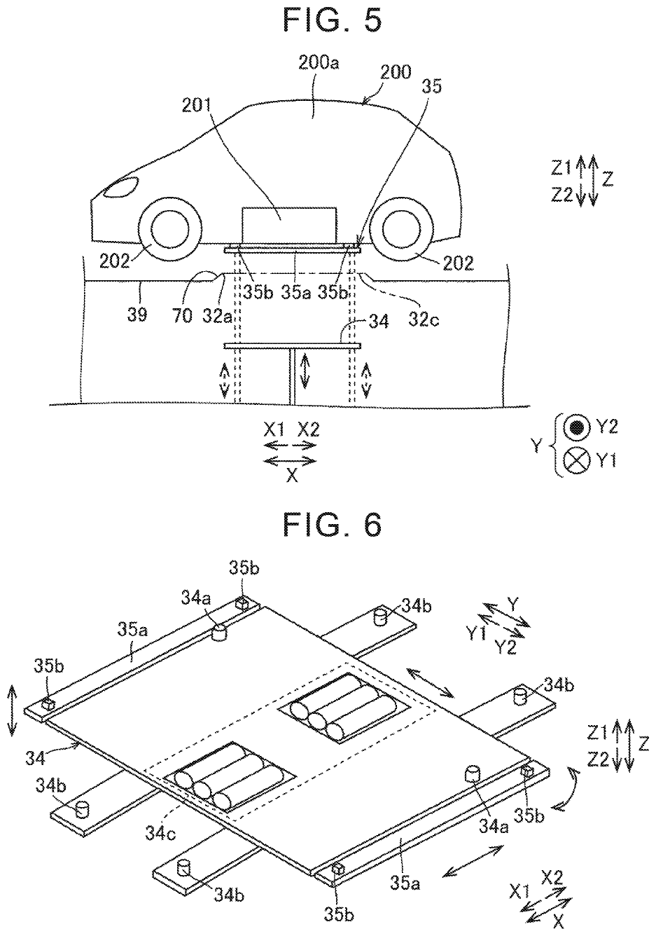

An opening plane 32c (see FIG. 5) of the opening 32a is located above the floor 39, and an inclined portion 70 is provided around the opening 32a. The inclined portion 70 inclines from the opening plane 32c toward the floor 39.

With the inclined portion 70, it is possible to reduce entry of foreign matter, wash fluid, or the like, dropping from the under side 200k of the vehicle 200 due to washing, into the opening 32a.

A drain route R that drains wash fluid is provided in the floor 39. The drain route R drains wash fluid to outside the vehicle stop area 103. A downstream of the drain route R may be connected to a collection unit (not shown) that collects wash fluid. An upstream of the drain route R may be connected to the inclined portion 70. In this case, it is possible to directly introduce wash fluid or the like, flowing from the inclined portion 70, into the drain route R. The drain route R may be omitted.

The example in which the inclined portion 70 is provided as described above has been described as the configuration to reduce entry of liquid, such as wash fluid, into the opening 32a; however, the configuration is not limited thereto. For example, the opening plane 32c of the opening 32a may be provided substantially flush with the floor 39, and the shutter 32 may be provided so as to close the opening 32a in a shape protruding upward from the opening plane 32c. In this case, in a state where the shutter 32 closes the opening 32a, it is possible to guide foreign matter, wash fluid, or the like, from the top of the shutter 32 toward the floor 39.

When the opening plane 32c is located above the floor 39 as described above, a wall (step) that is substantially perpendicular instead of the inclined portion 70 may be provided around the opening 32a. In this case, the shutter 32 may also be provided substantially flush with the opening plane 32c. With such a configuration as well, it is possible to guide foreign matter, wash fluid, or the like to the floor 39 along the step.

As described above, in a state where the opening 32a is closed by the shutter 32, at least part of the shutter 32 is provided so as to be located above the floor 39, so it is possible to guide foreign matter, wash fluid, or the like to the floor 39.

The drying device 50 is provided at the floor 39. The drying device 50 includes, for example, a first nozzle 51 and a second nozzle 52. The first nozzle 51 and the second nozzle 52 are disposed so as to face in the Y direction across the opening 32a.

The first nozzle 51 and the second nozzle 52 spray air toward the under side 200k of the vehicle 200 alternately. Specifically, the first nozzle 51 sprays air from one side in the right and left direction of the vehicle 200 toward the other side. The second nozzle 52 sprays air from the other side in the right and left direction of the vehicle 200 toward one side. The second nozzle 52 sprays air while the first nozzle 51 stops spraying air.

When the first nozzle 51 and the second nozzle 52 alternately spray air in this way, it is possible to dry the vehicle 200 washed with the washing device 40.

The drying device 50 is not limited to the mode including the first nozzle 51 and the second nozzle 52 as described above as long as the drying device 50 is provided so as to be capable of drying the vehicle 200. The number of nozzle units may be one or may be three or more. The locations of the nozzle units may be set as needed. The drying device 50 may spray hot air toward the vehicle 200. The drying device 50 is not limited to the mode provided at the floor 39. The drying device 50 just needs to be provided in the battery replacement station 100a.

The cameras 61 are provided so as to be capable of respectively capturing images of the under side 200k of the vehicle 200. The cameras 61 are disposed respectively in correspondence with the tool insertion holes 201f. The cameras 61 include two cameras 61 located adjacent to the front of the vehicle 200 stopped in the vehicle stop area 103 and two cameras 61 located adjacent to the rear of the vehicle 200. The two cameras 61 located adjacent to the front are respectively disposed on both sides of the opening 32a in the Y direction, and the two cameras 61 located adjacent to the rear are also respectively disposed on both sides of the opening 32a in the Y direction.

Each of the cameras 61 captures the image of a corresponding one of the tool insertion holes 201f. The cameras 61 have a waterproof structure so as to block entry of wash fluid. The cameras 61 and the image processing unit 62 function as an insertion detector that detects whether positioning pins 34a (described later) are respectively inserted in the positioning holes 208. The cameras 61 and the image processing unit 62 also function as a detachment detector that detects whether the battery 201 is detached.

FIG. 5 is a schematic diagram that shows the configuration below the floor of the battery replacement system according to the first embodiment. As shown in FIG. 5, the elevating unit 35 is provided so as to be movable in the up and down direction (Z direction). The elevating unit 35 is capable of moving up and down while holding the vehicle 200 from the lower side. The elevating unit 35 is provided so as to be allowed to pass through the opening 32a in a state where the opening 32a is open.

The elevating unit 35 includes a pair of elevating bars 35a. Each of the elevating bars 35a is provided with two projecting portions 35b projecting toward a Z1 side. The vehicle 200 is supported from the lower side by the two projecting portions 35b of each of the elevating bars 35a (that is, four projecting portions 35b).

FIG. 6 is perspective view that shows the battery mounting base of the battery replacement mechanism according to the first embodiment. As shown in FIG. 6, the battery mounting base 34 is provided with the two positioning pins 34a, the four lock-unlock tools 34b, and the roller units 34c.

A tapered surface 34d (see FIG. 10) is provided at the distal end of each of the positioning pins 34a. In other words, each positioning pin 34a has a tapered shape toward the Z1 side.

The battery mounting base 34 is configured to be movable in a horizontal direction below the vehicle 200. Specifically, the battery mounting base 34 is movable in the X direction (an X1 direction and an X2 direction) and in the Y direction (a Y1 direction and a Y2 direction). The battery mounting base 34 is rotatable so as to change the orientation (angle) in an XY-plane. Each of the elevating bars 35a may also be movable as in the case of the battery mounting base 34.

### Battery Replacement Flow

FIG. 7 is a flowchart that shows a battery replacement process of the battery replacement system according to the first embodiment. A battery replacement flow will be described with reference to FIG. 7.

### Sending of Vehicle Information and Other Information: Vehicle

Initially, in step S21, the vehicle 200 sends information on the vehicle 200 and information on the battery 201 to the communication unit 13 of the battery replacement system 100. For example, when operation to send the above pieces of information is performed on the navigation system (not shown) of the vehicle 200, the pieces of information are sent to the communication unit 13. The vehicle 200 sends the pieces of information before the vehicle 200 enters the battery replacement system 100. The pieces of information may be sent after the vehicle 200 enters the battery replacement system 100. Acquisition of Vehicle Information and Other Information: Battery Replacement System

Subsequently, in step S1, the communication unit 13 of the battery replacement system 100 acquires, through communication, information on the vehicle 200 and information on the battery 201, sent from the vehicle 200 in step S21. The acquired pieces of information are stored in the memory 12 (see FIG. 1).

Specifically, the communication unit 13 acquires information on the size (classification) of the vehicle 200. Information on the size of the vehicle 200 includes information on the overall length and width of the vehicle 200. Also, information on the size of the vehicle 200 may include information on the height and ground clearance of the vehicle 200.

The communication unit 13 acquires information on the size of the battery 201. Specifically, the communication unit 13 acquires information on the length and width of the battery 201. The communication unit 13 may acquire information on the height of the battery 201.

The communication unit 13 may acquire location information of the battery 201 and may acquire information on the capacity (charging capacity) of the battery 201 and the state of charge (SOC) of the battery 201.

Entry of Vehicle into Battery Replacement Station: Vehicle

When vehicle information and battery information are sent from the vehicle 200 to the communication unit 13 in step S1, the vehicle 200 enters the battery replacement station 100a by autonomous driving or by driving of a user in step S22.

### Stop of Vehicle in Vehicle Stop Area: Vehicle

Subsequently, in step S23, the vehicle 200 stops in the vehicle stop area 103. The vehicle 200 stops such that the wheels 202 are respectively placed on the corresponding sprags 31.

### Sending Instruction Signal for Battery Replacement Work: Vehicle

Subsequently, in step S24, the vehicle 200 stopped in the vehicle stop area 103 sends, to the communication unit 13, an instruction signal to start battery replacement work. The vehicle 200 turns off the SMR 204 (see FIG. 3) after sending the instruction signal to the communication unit 13. At this time, communication between the vehicle 200 and the communication unit 13 is maintained by electric power supplied from the auxiliary battery 206 (see FIG. 3).

### Receiving Instruction Signal for Battery Replacement Work: Battery Replacement System

Subsequently, in step S2, the communication unit 13 receives the instruction signal sent from the vehicle 200 in step S24. In step S2, the processor 11, after receiving the instruction signal, may send an instruction message or the like for causing the user of the vehicle 200 through the communication unit 13 to turn off the ignition power.

### Controlling Sprags: Battery Replacement System

Subsequently, in step S3, the processor 11 adjusts the locations of the sprags 31 (see FIG. 4) based on the information (vehicle information and battery information) acquired through the communication unit 13 in step S1.

Specifically, the processor 11 controls driving of the horizontal roller units 31b (see FIG. 4) based on information on the width of the vehicle 200. The processor 11 controls driving of the sliders 31c (see FIG. 2) based on the overall length of the vehicle 200. The processor 11 controls the sprags 31 (the horizontal roller units 31b and the sliders 31c) based on location information of the battery 201 with respect to the vehicle body 200a. Through these controls, the locations of each of the pressing members 31a in the X direction and in the Y direction are adjusted. The processor 11 may control each of the four sprags 31 independently of one another.

Thus, the location and orientation of the vehicle body 200a in the horizontal direction are adjusted, and the location and orientation of the battery 201 in the horizontal direction are adjusted. As a result, it is possible to move the battery 201 to a predetermined location above the opening 32a.

### Detecting State of Under Side of Vehicle: Battery Replacement System

Subsequently, in step S4, the state of the under side 200k of the vehicle 200 is detected. Specifically, the images of the under side 200k are respectively captured by the cameras 61. The image processing unit 62 processes the captured images and detects dirty conditions of the under side 200k. The cameras 61 do not need to capture the entire image of the under side 200k. The cameras 61 just need to respectively capture the images of the states of the positioning holes 208, the tool insertion holes 201f, or the heads of the fastening bolts 201g, needed for battery replacement, and detect dirty conditions of them. Detection information (image information) detected is input to the processor 11.

### Determining Whether to Wash: Battery Replacement System

Subsequently, in step S5, the processor 11 determines whether to wash. Specifically, the processor 11 determines that the under side 200k is dirty and washing is required, for example, when, in the images subjected to image processing, illuminances and the like vary within a predetermined range or a predetermined part cannot be found.

Particularly, when the positioning holes 208, the tool insertion holes 201f, or the heads of the fastening bolts 201g are not found, or when it is determined that foreign matter adheres to the positioning holes 208, the tool insertion holes 201f, or the fastening bolts 201g, the processor 11 determines that washing is required.

When the processor 11 determines that washing is required (YES in step S5), the processor 11 executes step S6. When the processor 11 determines that washing is not required (NO in step S5), the processor 11 executes step S7. A process of detecting the state of the under side 200k of the vehicle 200 (step S4, step S5) may be omitted, and the under side 200k of the vehicle 200 that stops in the vehicle stop area 103 may be washed.

### Washing of Under Side 200k of Vehicle: Battery Replacement System

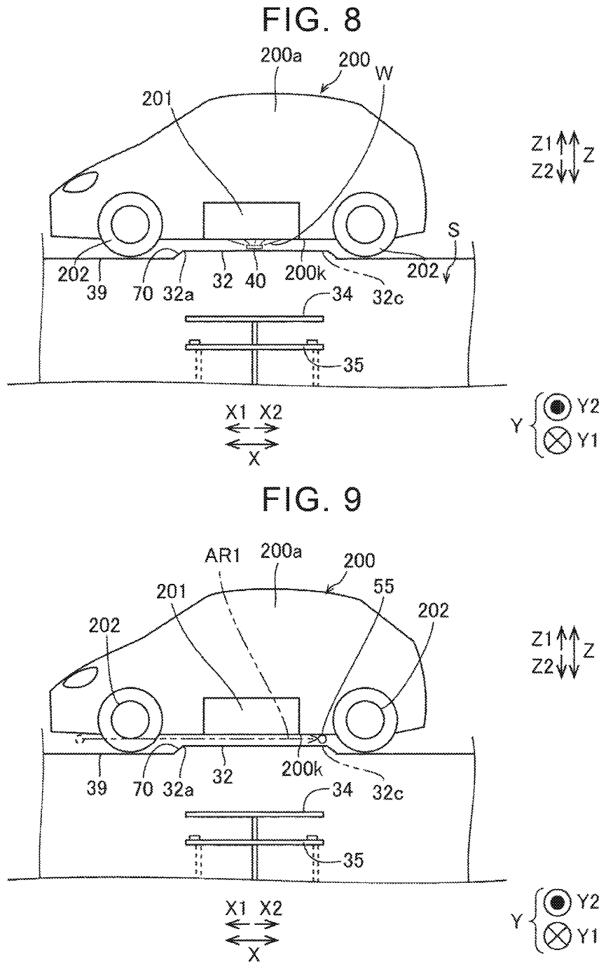

FIG. 8 is a diagram that shows a process of washing the under side of the vehicle in the battery replacement process shown FIG. 7.

Subsequently, in step S6, as shown in FIG. 8, the under side 200k of the vehicle 200 is washed before the battery 201 is detached. Specifically, a washing medium W is jetted from the nozzle units 43 while the washing device 40 is moved in the X direction and in the Y direction. The washing device 40 starts washing the under side 200k of the vehicle 200 after the communication unit 13 acquires stop information that the vehicle 200 has stopped in the vehicle stop area 103.

The washing device 40 washes the under side 200k in a state where the opening 32a is closed by the shutter 32. Thus, when liquid, such as wash fluid, is used as a washing medium, it is possible to reduce entry of the liquid to the underfloor area S through the opening 32a.

At the time of washing, the entire under side 200k does not need to be washed, and the positioning holes 208, the tool insertion holes 201f, or the heads of the fastening bolts 201g may be mainly washed. When the entire under side 200k is washed, mud and foreign matter adhering to the under side 200k are removed. Therefore, when the shutter 32 is open, it is possible to reduce drop of the mud and foreign matter to below the floor through the opening 32a. The washing device 40 may wash not only the under side 200k but also both sides of the vehicle 200 in the right and left direction.

The washing device 40 may wash the surface of the battery 201 (specifically, for example, the surface of the battery 201 exposed from the vehicle 200). In this case, it is possible to remove foreign matter adhering to the surface of the battery 201. Thus, it is possible to reduce storage of the battery 201 in the warehouse 100b in a process (described later) in a state where foreign matter is adhering to the battery 201 detached.

After washing with the washing device 40, the vehicle 200 is dried with the drying device 50. Specifically, the first nozzle 51 and the second nozzle 52 alternately spray air to dry the under side 200k of the vehicle 200 washed with the washing device 40.

FIG. 9 is a diagram that shows a state where the under side of the vehicle washed in the process of washing the under side of the vehicle is wiped with a wiping device.

As shown in FIG. 9, the battery replacement system 100 may include the wiping device 55. In this case, the wiping device 55 may wipe the under side 200k of the vehicle 200 washed with the washing device 40. The wiping device 55 is made up of, for example, a movable member, such as a brush, a sponge, a nonwoven fabric, and a wiper, configured to be movable. The wiping device 55 is, for example, provided so as to be movable in the X direction. When the wiping device 55 is moved as indicated by the arrow AR1, the wiping device 55 wipes the under side 200k.

### Opening of Opening in Battery Replacement Station: Battery Replacement System

Subsequently, in step S7, the processor 11 opens the opening 32a by opening the shutter 32. Thus, the battery replacement mechanism 33 is allowed to pass through the opening 32a, so it is possible to start work for replacing the battery 201.

### Holding Vehicle Body Horizontally: Battery Replacement System

Subsequently, in step S8, the processor 11 raises the elevating bars 35a in a state where the shutter 32 is open. Thus, the elevating bars 35a pass through the opening 32a, and the vehicle 200 is lifted by the elevating bars 35a. The processor 11 raises the elevating bars 35a to the predetermined height position to hold the vehicle 200 parallel to the horizontal direction.

In step S8, the processor 11 may adjust the positions of the elevating bars 35a based on the information from the vehicle 200, acquired in step S1. Specifically, the processor 11 may adjust a distance to raise the elevating bars 35a based on information on the ground clearance of the vehicle 200 or may change a distance between the elevating bars 35a based on the width of the vehicle 200.

### Detachment of Battery: Battery Replacement System

Subsequently, in step S9, the battery 201 is detached from the vehicle body 200a of the vehicle 200.

FIG. 10 is a diagram that shows a state where the positioning pin of the battery mounting base is inserted into the positioning hole of the vehicle in a process of detaching the battery.

Initially, the processor 11 raises the battery mounting base 34 by a distance based on information on the height position of the battery 201, acquired in step S6. Thus, as shown in FIG. 10, the positioning pin 34a is inserted into the positioning hole 208. The positioning pin 34a corresponds to an insertion portion provided so as to be insertable in the positioning hole 208.

The tapered surface 34d is provided at the distal end of the positioning pin 34a. The positioning pin 34a is guided by the tapered surface 34d and inserted into the positioning hole 208.

FIG. 11 is a diagram that shows a state where the lock-unlock tool is inserted into the tool insertion hole in the process of detaching the battery. As shown in FIG. 11, in a state where the positioning pin 34a is guided to the positioning hole 208, the battery mounting base 34 is further raised, with the result that the lock-unlock tool 34b is inserted into the tool insertion hole 201f.

FIG. 12 is a diagram that shows a state where the lock-unlock tool unlocks the fastening bolt in the process of detaching the battery. As shown in FIG. 12, the processor 11 raises the lock-unlock tool 34b in a state where the lock-unlock tool 34b is inserted in the tool insertion hole 201f.

The fastening bolt 201g has a head at the lower side. In a state where the lock-unlock tool 34b is engaged with the head, the processor 11 drives (rotates) the lock-unlock tool 34b inserted in the tool insertion hole 201f. Thus, the fastening bolt 201g in the tool insertion hole 201f is unlocked. As a result, the battery 201 is detached from the vehicle body 200a and is mounted on the battery mounting base 34. The lock-unlock tool 34b corresponds to a fastening release portion that releases fastening of the fastening bolt 201g.

In the above-described series of operations, the timing at which the positioning pin 34a is inserted into the positioning hole 208 and the timing at which the lock-unlock tool 34b is inserted into the tool insertion hole 201f may coincide with each other.

### Checking of Detachment of Battery: Battery Replacement System

In step S10, the processor 11 determines whether the battery 101 is detached.

Specifically, for example, whether the positioning pins 34a are respectively inserted in the positioning holes 208 is detected. The cameras 61 may be used as an insertion detecting device that detects an insertion state. In this case, whether each of the positioning pins 34a is inserted in a corresponding one of the positioning holes 208 or located outside the corresponding one of the positioning holes 208 is captured with a corresponding one of the cameras 61. For example, a marker may be provided on each of the positioning pins 34a, and whether the marker is located inside the positioning hole 208 and not seen or the marker is exposed to outside the positioning hole 208 may be checked.

Alternatively, whether the lock-unlock tool 34b is inserted in the tool insertion hole 201f or whether the fastening bolt 201g in a fastened state is unlocked with the lock-unlock tool 34b may be detected.

When the processor 11 determines that the battery 101 is detached (YES in step S10), the processor 11 executes step S11 and step S12. When the processor 11 determines that the battery 101 cannot be detached (NO in step S10), the processor 11 executes step S10A.

Checking of Number of Times of Determination that Battery Cannot be Detached: Battery Replacement System

Subsequently, in step S10A, the processor 11 checks whether the number of times of determination that the battery 201 cannot be detached is less than a reference value n (n is an integer greater than or equal to two).

Specifically, for example, the processor 11 checks whether the number of times of repetition of detection that the positioning pins 34a are not respectively inserted in the positioning holes 208 with the insertion detector (cameras 61) and washing of the positioning holes 208 with the washing device 40 is less than the reference value n.

The processor 11 checks whether the number of times of repetition of detection that the lock-unlock tools 34b are not respectively inserted in the tool insertion holes 201f or detection that the fastening bolts 201g in a fastened state are not respectively unlocked with the lock-unlock tools 34b with a detachment detector that detects whether to detach the battery 101, and washing of the positioning holes 208 with the washing device 40 is less than the reference value n.

When the processor 11 determines that the number of times of determination that the battery 201 cannot be detached is less than the reference value n (YES in step S10A), the processor 11 repeatedly executes from step S6.

More specifically, when the insertion detector detects that the positioning pins 34a are not respectively inserted in the positioning holes 208, the washing device 40 washes the positioning holes 208. Similarly, when the detachment detector detects that the lock-unlock tools 34b are not respectively inserted in the tool insertion holes 201f or detects that the fastening bolts 201g in a fastened state are not respectively unlocked with the lock-unlock tools 34b, the washing device 40 washes the tool insertion holes 201f and/or the heads of the fastening bolts 201g.

When the processor 11 determines that the number of times of determination that the battery 201 cannot be detached is greater than or equal to the reference value n (NO in step S10A), the processor 11 executes step S10B.

Notification of Warning with Warning Notification Unit: Battery Replacement System

In step S10B, the processor 11 notifies a warning with the warning notification unit 85 to inform the user or the like that detachment of the battery 201 is difficult.

### Conveying Battery to Warehouse: Battery Replacement System

Subsequently, in step S11, the battery 201 detached from the vehicle body 200a in step S9 is conveyed to the warehouse 100b.

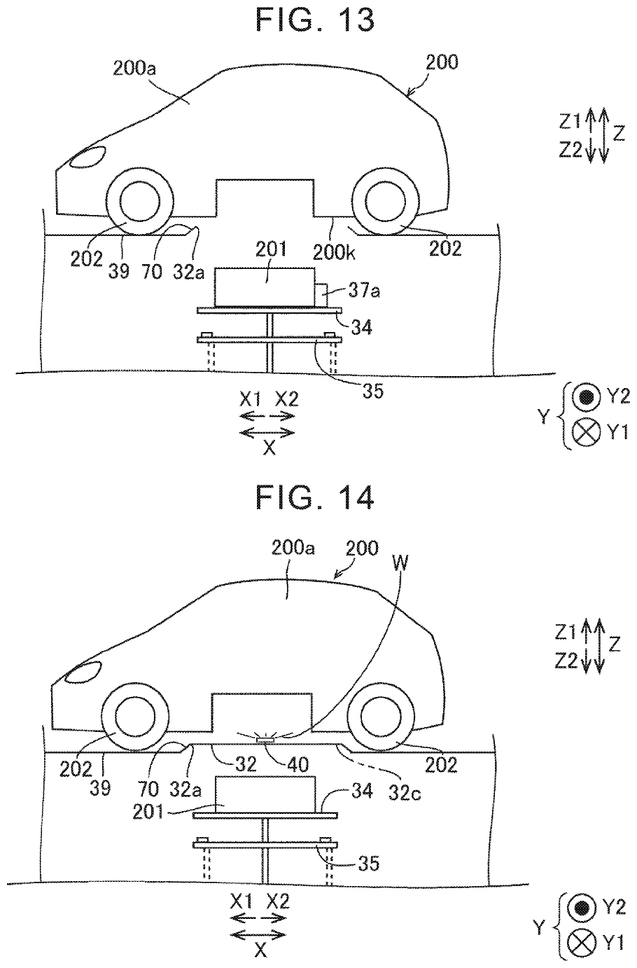

FIG. 13 is a diagram that shows a process of conveying the battery detached from the vehicle. As shown in FIG. 13, the processor 11 lowers the battery mounting base 34 on which the battery 201 is mounted to the height position of the conveying unit 36 (see FIG. 1).

The processor 11 lowers the elevating unit 35 (elevating bars 35a) to a position below the battery mounting base 34. Thus, the vehicle body 200a of the vehicle 200 is mounted on the floor 39 without being held by the elevating bars 35a.

Subsequently, the processor 11 drives the roller units 34c (see FIG. 5) of the battery mounting base 34. Thus, the battery 201 mounted on the battery mounting base 34 is transferred to the conveying unit 36. The battery 201 transferred to the conveying unit 36 is conveyed to the temporary storage space 90 and then stored in the warehouse 100b by another conveying device (not shown).

### Washing of Under Side 200k of Vehicle: Battery Replacement System

FIG. 14 is a diagram that shows a process of washing the under side of the vehicle after the battery is detached from the vehicle. As shown in FIG. 14, in step S12, the under side 200k of the vehicle 200 is washed in parallel with step S11.

Specifically, the processor 11 closes the shutter 32 to close the opening 32a in a state where the elevating unit 35 and the battery mounting base 34 are lowered to the underfloor area S. In this state, a washing medium is jetted from the nozzle units 43 while the washing device 40 is moved in the X direction and in the Y direction.

In this way, when the under side 200k of the vehicle 200 is washed after the battery 201 is detached from the vehicle 200, it is possible to wash an area of the under side 200k, which will cover the top surface of battery 201. When the positioning holes 208 and the tool insertion holes 201f are washed again, it is possible to avoid a situation in which another battery 101 cannot be attached due to foreign matter remaining in the positioning holes 208 or the tool insertion holes 201f.

### Attachment of Another Battery: Battery Replacement System

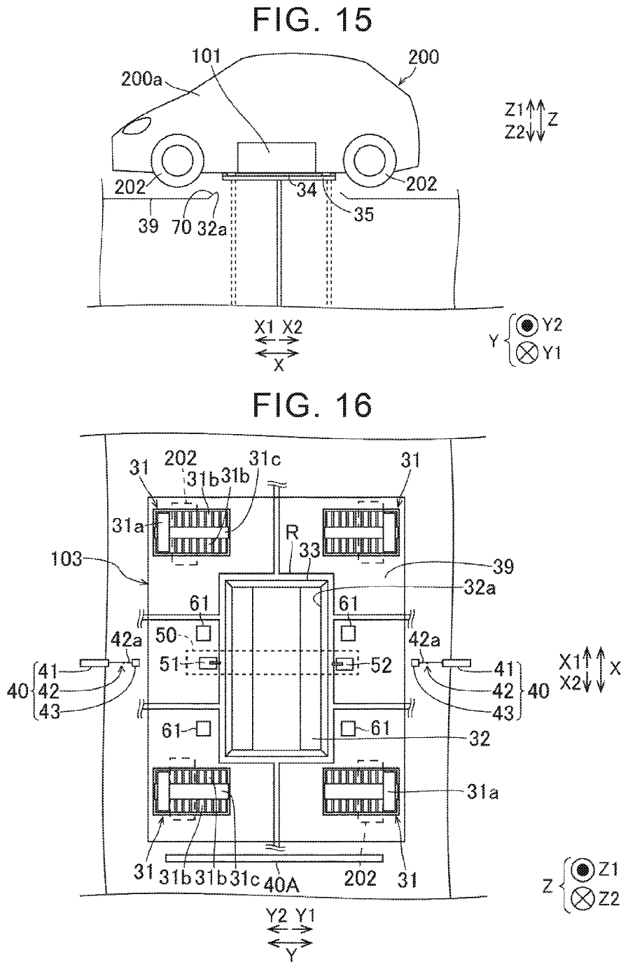

FIG. 15 is a diagram that shows a process of attaching another battery to the vehicle. Subsequently, as shown in FIG. 15, in step S13, the processor 11 controls to attach another battery 101 to the vehicle body 200a.

Specifically, the processor 11 raises the elevating unit 35 (elevating bars 35a) to hold the vehicle 200 parallel to the horizontal direction at the predetermined height position. Subsequently, the processor 11 raises the battery mounting base 34 on which another battery 101 is mounted, to respectively insert the positioning pins 34a to the positioning holes 208. In this state, the processor 11 raises the lock-unlock tools 34b to be respectively inserted to the positioning holes 208h. Subsequently, the processor 11 drives (rotates) the lock-unlock tools 34b to respectively lock the fastening bolts in the tool insertion holes.

When locking of all the fastening bolts is detected, the vehicle-side connector 210 is locked with a connector of the battery 101. As a result, attachment of the battery 101 to the vehicle body 200a completes.

### Retraction of Battery Mounting Base and Elevating Unit: Battery Replacement System

Subsequently, in step S14, the processor 11 lowers the battery mounting base 34 and the elevating unit 35 to a predetermined position. The vehicle 200 is mounted on the floor 39, and the processor 11 closes the shutter 32. Notification of Completion of Battery Replacement Work: Battery Replacement System

Subsequently, in step S15, the processor 11 notifies the vehicle 200 through the communication unit 13 that battery replacement work is complete. The processor 11 notifies the vehicle 200 of information on washing. Specifically, for example, the number of times of washing, washing cost, or the images of the under side 200k and the like captured after washing are notified.

### Receiving Notification of Completion of Battery Replacement Work: Vehicle

In step S25, the vehicle 200 receives the notification sent from the communication unit 13 of the battery replacement system 100 in step S15. Thus, the vehicle 200 is placed in a state where the ignition power is allowed to be turned on. After that, the process is ended.

Through the above-described processes, the battery 201 is replaced with another battery 101 by the battery replacement system 100.

### Second Embodiment

FIG. 16 is a plan view that shows the configuration of a battery replacement station of a battery replacement system according to a second embodiment. The battery replacement system according to the second embodiment will be described with reference to FIG. 16.

As shown in FIG. 16, the battery replacement system according to the second embodiment differs from the battery replacement system 100 according to the first embodiment in that a washing device 40A provided forward of the vehicle stop area 103 is included.

The washing device 40A is provided so as to be capable of washing the under side 200k of the vehicle 200 that enters the vehicle stop area 103. The washing device 40A is, for example, provided in a line shape so as to extend in the Y direction.

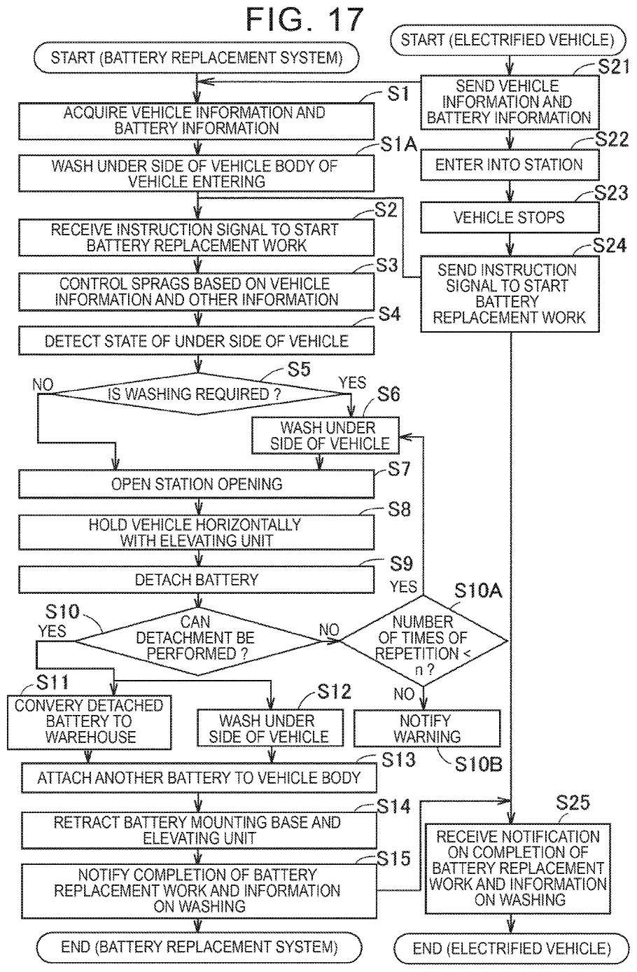

FIG. 17 is a flowchart that shows a battery replacement process of the battery replacement system according to the second embodiment. A battery replacement flow of the battery replacement system according to the second embodiment will be described with reference to FIG. 17.

In the second embodiment, battery replacement is performed basically in conformity with the battery replacement flow according to the first embodiment. The second embodiment differs from the first embodiment in that step IA is provided between step S1 and step S2.

In step S1A, the under side 200k of the vehicle 200 is washed with the washing device 40A before the vehicle 200 enters the vehicle stop area 103. Thus, it is possible to wash the vehicle 200 before battery replacement is started. Furthermore, since the washing device 40A is provided forward of the vehicle stop area 103, it is possible to reduce entry of wash fluid into the vehicle stop area 103.

Since the under side 200k of the vehicle 200 is washed in step S1A, step S4, step S5, step S6, step S10, step S10A, step SOB, and step S12 in the battery replacement flow according to the first embodiment may be omitted in the second embodiment.

### Third Embodiment

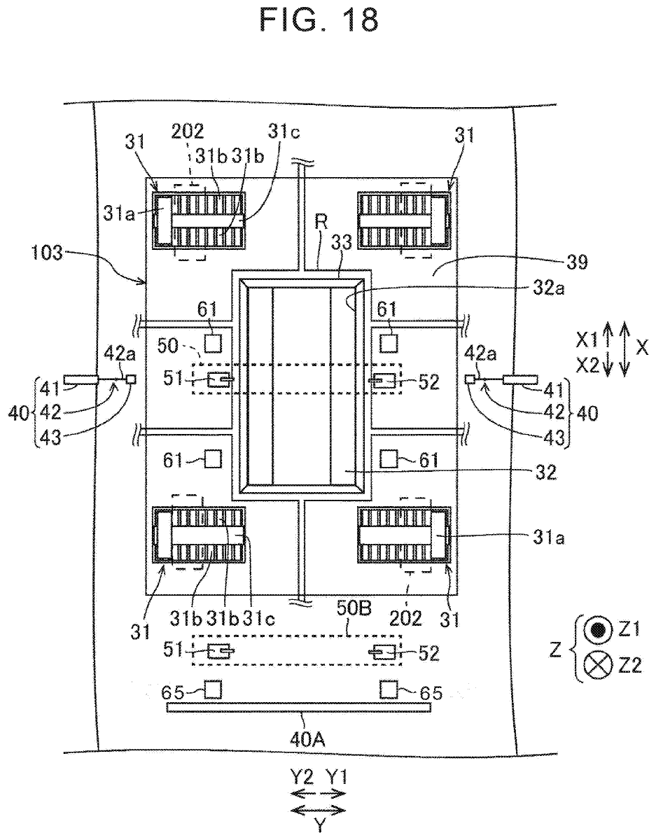

FIG. 18 is a plan view that shows the configuration of a battery replacement station of a battery replacement system according to a third embodiment. The battery replacement system according to the third embodiment will be described with reference to FIG. 18.

As shown in FIG. 18, the battery replacement system according to the third embodiment differs from the battery replacement system according to the second embodiment in that a drying device 50B and a location detection mechanism 65 are further included. The remaining configuration is substantially the same.

The drying device 50B is disposed between the vehicle stop area 103 and the washing device 40A. In other words, the washing device 40A and the drying device 50B are disposed forward of the vehicle stop area (on an upstream side in a direction in which the vehicle enters) so as to be arranged in the direction in which the vehicle enters. The drying device 50B is disposed closer to the vehicle stop area 103 than the washing device 40A. The drying device 50B has a substantially similar configuration to the drying device 50.

With the thus configured drying device 50B, it is possible to dry the vehicle 200 washed with the washing device 40A before the vehicle 200 enters the vehicle stop area 103.

The location detection mechanism 65 is provided so as to be capable of detecting the location of the vehicle 200. The location detection mechanism 65 detects that the vehicle 200 is located above the washing device 40A. The location information of the vehicle 200, detected by the location detection mechanism 65, is input to the processor 11.

The location detection mechanism 65 includes, for example, a plurality of cameras. The location detection mechanism 65 captures images of the vehicle 200 with the cameras to detect whether the vehicle 200 is located above the washing device 40A. The location detection mechanism 65 is not limited to the cameras and may be a weight sensor, a radar, or the like.

When a weight sensor is used as the location detection mechanism 65, the location of the vehicle 200 is detected by detecting the weight of the vehicle 200. When a radar is used as the location detection mechanism 65, for example, the location of the vehicle 200 is detected by detecting a distance between the vehicle stop area 103 and the vehicle 200.

In the third embodiment, battery replacement is performed in conformity with the battery replacement flow according to the second embodiment. In the third embodiment, in step S1A, before the vehicle 200 enters the vehicle stop area 103, the under side 200k of the vehicle 200 is washed with the washing device 40A, and the vehicle 200 washed is dried with the drying device 50B.

More specifically, when the location detection mechanism 65 detects that the vehicle 200 is located above the washing device 40A, the processor 11 activates the washing device 40A based on detection information. Thus, washing with the washing device 40A is performed. Subsequently, before the vehicle 200 enters the vehicle stop area 103, the vehicle 200 washed is dried with the drying device 50B. Thus, it is possible to reduce drop of wash fluid or the like from the vehicle 200 in the vehicle stop area 103.

In the third embodiment as well, since the under side 200k of the vehicle 200 can be washed in step S1A, step S4, step S5, step S6, step S10, step S10A, step S10B, and step S12 in the battery replacement flow according to the first embodiment may be omitted in the third embodiment. In this case, the washing device 40 and the drying device 50 according to the first embodiment may be omitted.

In the first to third embodiments, the example in which the battery 201 is fixed to the under side 200k of the vehicle 200 and the under side 200k of the vehicle 200 is washed with the washing device 40 or the washing device 40A has been described; however, the configuration is not limited thereto. When the battery 201 is fixed to the side of the vehicle 200, the side of the vehicle 200 may be washed with the washing device 40 or the washing device 40A. In this way, at least one of the area of the vehicle 200 where the battery replacement mechanism 33 contacts with the vehicle 200 and the under side 200k just needs to be washed.

Furthermore, in the first to third embodiments, the example in which the battery 101 or the battery 201 is detachably fixed to the vehicle body 200a with the fastening bolts 201g serving as fastening devices has been described; however, the configuration is not limited thereto. The battery 101 or the battery 201 may be detachably fixed to the vehicle body 200a with a latch structure, a magnet, or the like serving as a fastening device.

In this way, the content of the disclosure is applicable to the vehicle 200 in which the battery 201 is fixed to the vehicle body 200a by a plurality of fastening devices so that the battery can be unlocked. In this case, the battery replacement system includes a fixation releasing portion that releases a fixed state where the battery 201 is fixed to the vehicle body 200a by the plurality of fastening devices. The washing device 40 or the washing device 40A may be provided so as to be capable of washing an area in which the fixation releasing portion contacts with a fixing part in any one of step S1, step S6, and step S12 in the battery replacement flow.

The embodiments described above are illustrative and not restrictive in all respects. The scope of the disclosure is defined by the appended claims. The scope of the disclosure encompasses all modifications within the meaning and scope equivalent to the appended claims.

1. A battery replacement system for replacing a first battery attached to a vehicle, with a second battery, the battery replacement system comprising:
a battery replacement mechanism configured to detach the first battery from the vehicle and attach the second battery to the vehicle; and
a washing device configured to wash part of the vehicle, wherein the washing device is configured to, before the battery replacement mechanism detaches the first battery, wash at least one of an area of the vehicle where the battery replacement mechanism contacts with the vehicle and an under side (290k) of the vehicle.

2. The battery replacement system according to claim 1, further comprising a vehicle stop area where the vehicle is stopped, wherein the washing device is provided so as to be capable of washing the vehicle stopped in the vehicle stop area.

3. The battery replacement system according to claim 2, wherein:
the vehicle stop area includes an opening that allows the battery replacement mechanism to pass through and a shutter configured to openably close the opening; and
the washing device is configured to wash the under side of the vehicle in a state where the opening is closed by the shutter.

4. The battery replacement system according to claim 3, wherein:
the vehicle stop area includes a floor that faces the under side of the vehicle; and
the shutter is provided so as to be at least partially located above the floor in a state where the opening is closed by the shutter.

5. The battery replacement system according to claim 4, wherein:
the washing device is configured to wash the under side of the vehicle by jetting wash fluid toward the vehicle; and
the floor is provided with a drain channel configured to drain the wash fluid.

6. The battery replacement system according to claim 2, further comprising a vehicle information acquisition unit configured to acquire information from the vehicle, wherein:
the vehicle information acquisition unit is provided so as to be capable of acquiring stop information on a stop of the vehicle in the vehicle stop area; and
the washing device is configured to, after the vehicle information acquisition unit acquires the stop information, start washing the under side of the vehicle.

7. The battery replacement system according to claim 2, further comprising a vehicle information acquisition unit configured to acquire information from the vehicle, wherein:
the washing device is provided so as to be movable; and
the washing device is configured to move to a washing location based on the information from the vehicle, acquired by the vehicle information acquisition unit.

8. The battery replacement system according to claim 1, wherein:
the under side of the vehicle includes a positioning hole for positioning with the battery replacement mechanism; and
the washing device is configured to wash the positioning hole.

9. The battery replacement system according to claim 8, wherein:
the battery replacement mechanism includes an insertion portion provided so as to be insertable in the positioning hole;
the battery replacement system further comprises an insertion detector configured to detect whether the insertion portion is inserted in the positioning hole; and
the washing device is configured to, when the insertion detector detects that the insertion portion is not inserted in the positioning hole, wash the positioning hole.

10. The battery replacement system according to claim 9, further comprising a warning notification unit configured to, when the insertion detector detects that the insertion portion is not inserted in the positioning hole after, repeatedly, the insertion detector detects that the insertion portion is not inserted in the positioning hole and the washing device washes the positioning hole, notify a warning.

11. The battery replacement system according to claim 1, wherein:
the washing device is configured to wash the vehicle by jetting liquid toward the vehicle; and
the battery replacement system further comprises a drying device configured to dry the vehicle washed with the washing device.

12. The battery replacement system according to claim 1, wherein:
the washing device is configured to wash the vehicle by jetting liquid toward the vehicle; and
the battery replacement system further comprises a wiping device configured to wipe the liquid adhering to the vehicle washed with the washing device.

13. The battery replacement system according to claim 1, wherein:
the washing device is configured to wash the vehicle by jetting a washing medium toward the vehicle; and
the battery replacement system further comprises a heating device configured to heat the washing medium.

14. The battery replacement system according to claim 1, wherein:
the first battery is releasably fixed to a vehicle body by a plurality of fastening devices;
the battery replacement mechanism includes a fixation releasing portion configured to release a fixed state where the first battery is fixed to the vehicle body by the plurality of fastening devices; and
the washing device is configured to wash an area where the fixation releasing portion contacts with the fastening devices.

15. The battery replacement system according to claim 1, wherein the washing device is configured to, before the second battery is attached to the vehicle, further wash the under side of the vehicle placed in a state where the first battery is detached by the battery replacement mechanism.

16. The battery replacement system according to claim 1, further comprising a vehicle stop area where the vehicle is stopped, wherein the washing device is provided forward of the vehicle stop area.

17. The battery replacement system according to claim 16, wherein:
the washing device is configured to wash the vehicle by jetting liquid toward the vehicle;
the battery replacement system further comprises a drying device configured to dry the vehicle washed with the washing device;
the washing device and the drying device are disposed forward of the vehicle stop area so as to be arranged in a direction in which the vehicle enters; and
the drying device is disposed closer to the vehicle stop area than the washing device.

18. The battery replacement system according to claim 16, further comprising a location detection mechanism configured to detect a location of the vehicle, wherein the washing device is configured to, when the location detection mechanism detects that the vehicle is located above the washing device, wash the vehicle.

19. The battery replacement system according to claim 1, wherein the washing device is provided so as to be capable of washing a surface of the first battery, exposed from the vehicle, in a state mounted on the vehicle.
